(19) United States
(12) Patent Application Publication
(10) Pub. No.: US 2011/0099249 A1
(43) Pub. Date: Apr. 28, 2011

(54) Method Of Storing And Reproducing Contents

(75) Inventors: Hyun-Wook Cho, Daegu (KR); Dae-Gyue Park, Daegu (KR)

(73) Assignee: Samsung Electronics Co., Ltd., Suwon-s, Gyeonggi-do (KR)

(21) Appl. No.: 10/584,239

(22) PCT Filed: Dec. 24, 2004
(86) PCT No.: PCT/KR2004/003438

§ 371 Date: Jul. 1, 2008

(30) Foreign Application Priority Data
Dec. 26, 2003 (KR) 10-2003-0097574
Dec. 21, 2004 (KR) 10-2004-0109940

(51) Int. Cl. G06F 15/16

(52) U.S. Cl. 709/219

(57) ABSTRACT

A method of storing and reproducing contents in a terminal capable of storing and outputting contents such as pictures or music is provided. When the terminal connects to a contents server and downloads contents from the contents server, it stores the downloaded contents along with its terminal identification information. When reproducing stored contents, the terminal compares terminal identification information attached to the contents with its terminal identification. If they are identical, the terminal reproduces the contents.

### BACKGROUND OF THE INVENTION

1. Field of the Invention

The present invention relates generally to a contents processing method in a variety of terminals including a mobile phone and a portable terminal such as a PDA (Personal Digital Assistant) and a laptop computer (hereinafter, a portable terminal is taken as an example for better understanding of the present invention), and in particular, to a contents storing and reproducing method for preventing indiscriminate downloading of contents and allowing contents exchange between terminals.

2. Description of the Related Art

As terminals capable of processing various contents, for example, portable terminals have recently been equipped with the functions of MOD (Music On Demand) and VOD (Voice On Demand) in addition to voice call and wireless Internet browsing, they are connected to diverse contents server like MOD and VOD servers by wired or wireless Internet access, download contents to their memories in real time, store them, and reproduce them (MOD contents, VOD contents, etc.)

In the case of contents received from a contents server, especially paid contents, the contents are so configured as not to be exchanged directly between terminals. Therefore, a user accesses a desired contents server, searches for contents, and downloads them. Despite the presence of desired contents among contents downloaded to other terminals around him, the user inconveniently accesses a server via wireless Internet and searches for the desired contents.

Even when he can get the contents by exchanging data with the terminal of the other party, the user must be connected to the server and search for the contents. Hence, he must pay for the contents from the server.

### SUMMARY OF THE INVENTION

An object of the present invention is to substantially solve at least the above problems and/or disadvantages and to provide at least the advantages below. Accordingly, an object of the present invention is to provide a contents storing and reproducing method for preventing indiscriminate downloading of contents and allowing contents exchange between terminals.

Another object of the present invention is to provide a contents storing and reproducing method for allowing contents exchange between terminals, charging them for the information use.

A further object of the present invention is to provide a contents storing and reproducing method for allowing contents exchange between terminals such that contents can be reproduced only with charges for information use, not with packet data charges which are imposed in downloading of contents.

The above objects are achieved by providing a method of storing and reproducing contents in a terminal capable of storing and outputting contents such as pictures or music. When the terminal connects to a contents server and downloads contents from the contents server, it stores the downloaded contents along with its terminal identification information. When reproducing stored contents, the terminal compares terminal identification information attached to the contents with its terminal identification. If they are identical, the terminal reproduces the contents.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a portable terminal according to an embodiment of the present invention;

FIGS. 2A and 2B are flowcharts illustrating an operation for reproducing contents according to the embodiment of the present invention; and

FIG. 3 is a detailed flowchart illustrating an operation for registering contents normally in the procedure of FIG. 2B.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

The term used herein “portable terminal identification information” refers to the MIN (Mobile Identification Number) and ESN (Electronic Serial Number) of a portable terminal that has downloaded contents. “Contents” is used to cover every type of contents including VOD contents and MOD contents in its sense.

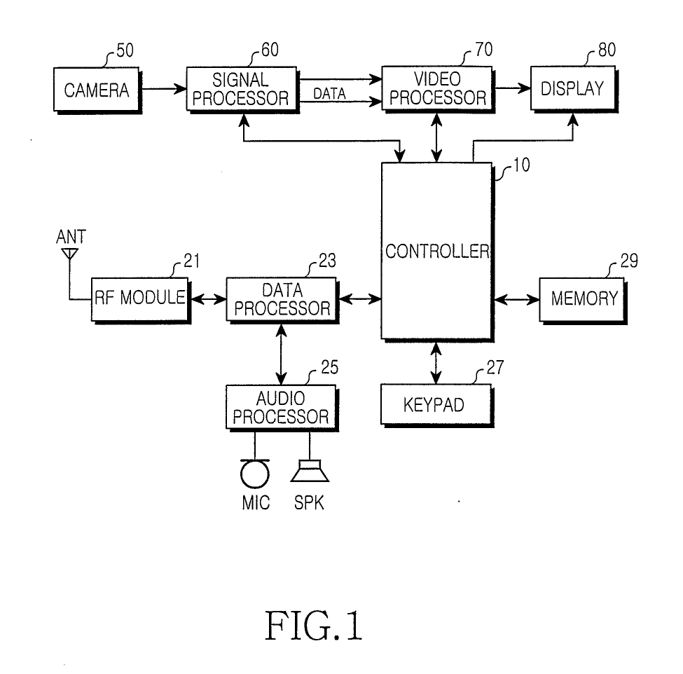

FIG. 1 is a block diagram of a portable terminal according to an embodiment of the present invention.

Referring to FIG. 1, an RF (Radio Frequency) module 21 performs communications for the portable terminal. It includes an RF transmitter for upconverting and amplifying a transmission signal and an RF receiver for low-noise amplifying and downconverting a received signal.

A data processor 23 is provided with a transmitter for encoding and modulating the transmission signal and a receiver for demodulating and decoding the received signal. Thus, the data processor 23 can be comprised of a MODEM and a CODEC.

An audio processor 25 reproduces an audio signal received from the data processor 23 or transmits an audio signal received from a microphone (MIC) to the data processor 23. It also outputs a voice signal generated during reproducing contents to a speaker (SPK) according to the embodiment of the present invention.

A keypad 27 has alphanumerical keys for entering digits and characters and functions for setting various functions. It may have a service connection key and a contents reproduction key according to the embodiment of the present invention.

A memory 29 may include a program memory and a data memory. The program memory stores programs for controlling the typical operation of the portable terminal. According to the embodiment of the present invention, it stores a program for storing contents along with the portable terminal identification information (i.e. the MIN and ESN) of the portable terminal when the portable terminal is connected to a server and downloads the contents from the server, and a program for reproducing contents by comparing the portable terminal identification information of the portable terminal with portable terminal identification information attached to the contents. The data memory temporarily stores data generated during executing the programs. The portable terminal identification information may be stored in an SIM (Subscriber Identification Module) or a UIM (User Identification Module).

A controller 10 provides overall control to the portable terminal. The controller 10 may incorporate the data processor 23 therein. According to the embodiment of the present invention, the controller 10 controls contents data downloaded from a server to be stored along with the portable terminal identification information. Also, it controls the whole operation of contents reproduction involving comparison between portable terminal identification information attached to contents to be reproduced with the portable terminal identification information of the portable terminal. If they are different, the controller 10 accesses a server and updates the portable terminal identification information of the contents. The controller 10 includes a decoder for decoding contents.

A camera 50 captures an image, including a camera sensor for converting a captured optical signal to an electrical signal. The camera sensor is assumed to be a CCD (Charge Coupled Device) sensor herein. A signal processor 60 converts the video signal received from the camera 50 to an image signal. The signal processor 60 can be implemented as a DSP (Digital Signal Processor).

A video processor 70 generates screen data by which the video signal received from the signal processor can be displayed. The video processor 70 transmits a video signal received under the control of the controller 10 or video data captured by the camera 50 in the form suitable for a display 80, and compresses and decompresses the video data.

The display 80 displays messages generated during executing programs under the control of the controller 10. According to the embodiment of the present invention, the display 80 displays contents reproduced under the control of the controller 10. The display 80 can use an LCD (Liquid Crystal Display). In this case, the display 80 includes an LCD controller, a memory for storing video data, and an LCD device. If the LCD is implemented as a touch screen, both the keypad 27 and the LCD serve as an input portion.

In operation, when a user dials through the keypad 27 and sets an origination mode, the controller 10 senses it, processes received dialing information through the data processor 21, and converts the processed information to an RF signal prior to transmission. Upon generation of a response signal from a called, the controller 10 senses it through the RF module 21 and the data processor 23. A voice communication path is then established through the audio processor so that the user can converse. In a termination mode, the controller 10 senses the termination mode through the data processor 23 and generates a ring signal through the audio processor 25. When the user answers, the controller 10 senses the answer and establishes the voice communication path through the audio processor so that the user can converse. While the origination and termination modes have been described in relation to a voice call, they are applied in the same manner to data communication including packet data and video data. In an idle mode or in text communications, the controller 10 displays text data processed by the data processor 23 on the display 80.

Besides, the portable terminal can photograph an object or surroundings and display or transmit the captured image. The camera 50 can be built in the portable terminal or externally connected to a predetermined portion of the portable terminal. In other words, the camera 50 can be an in-built or external one. The camera 50 can use a CCD sensor. An image captured by the camera 50 is converted to an electrical signal in the CCD sensor. The signal processor 60 converts the video signal received from the CCD sensor to digital video data and outputs it to the video processor 70.

Regarding processing downloaded contents in the portable terminal, when the user presses the service connection key through the keypad 27, the controller 10 is connected to a service. If contents to be downloaded are selected among serviced contents, the controller 10 stores contents and the portable terminal identification information in the memory 29. If the user selects contents by pressing the contents reproduction key through the keypad 27, the controller 10 reads portable terminal identification information attached to the contents and compares it with the portable terminal identification information of the portable terminal.

If the read portable terminal identification information is identical to the portable terminal identification information of the portable terminal, the controller 10 reproduces the contents and displays them on the display 80.

On the other hand, if the contents were received from another portable terminal, the read portable terminal identification information is different from the portable terminal information of the portable terminal. In this case, the controller 10 cannot reproduce the contents.

The controller 10 is then connected to the server and requests registration of the contents. Being charged for the information use of the contents, the controller 10 updates the portable terminal identification information of the contents and stores it in the memory 29.

Since the updated portable terminal identification information is now identical to the portable terminal identification information of the portable terminal, the controller 10 reproduces the contents and displays them on the display 80.

While the portable terminal illustrated in FIG. 1 is so configured as to reproduce contents by the controller 10 including a decoder (not shown), it may be further provided with a chip for processing only contents independently of the controller 10 for the same operation of the present invention.

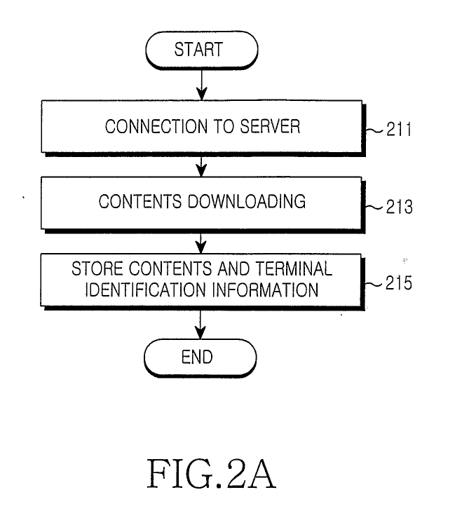

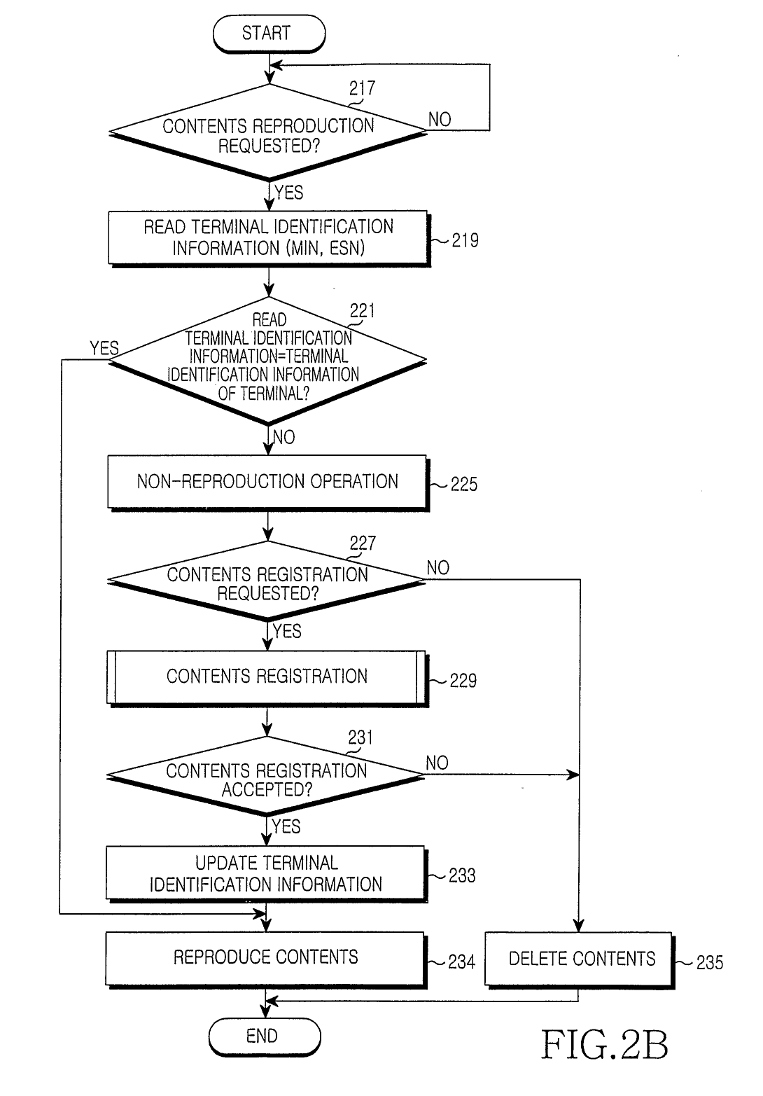

FIGS. 2A and 2B are flowcharts illustrating a contents reproducing method according to the embodiment of the present invention. Specifically, FIG. 2A depicts connection to a contents server and downloading of contents from the contents server in the portable terminal and FIG. 2B depicts reproduction of stored contents in the portable terminal.

Referring to FIG. 2A, the controller 10 is connected to the contents server as the user manipulates the portable terminal for Internet connection and connection to the contents server in step 211. The contents server then transmits a table of contents available for service to the portable terminal. The controller 10 displays the table of contents on the display 80.

When the user selects desired contents from the table of contents using directional keys in the keypad 27, the controller 10 requests the selected contents to the contents server and downloads them in step 213. Charges for the downloaded contents are usually added to the service charge of the portable terminal.

In step 215, the controller 10 stores the downloaded contents along with the portable terminal identification information of the portable terminal in the memory 29. The portable terminal identification information is filled in a header field of a contents format, as illustrated in Table 1 below.

TABLE 1
Portable terminal identification information

| Field | Field size | Value (example) |
|---|---|---|
| MIN | 44 bits | 0113456789 |
| ESN | 32 bits | B99BF43D |

MIN is the 44-bit phone number of the portable terminal. To describe MIN in detail, MIN is divided into MIN 1 and MIN 2. MIN 1 is the part of the phone number, “3456789”, other than a number indicating a mobile communication service provider, and MN 2 indicates the number indicating the mobile communication service provider, “011”.

ESN is the 32-bit electronic serial number of the portable terminal, for example, “B99BF43D”. Mass-produced portable terminals have different ESNs.

In this way, the downloaded contents are stored along with the portable terminal identification information. When stored contents are reproduced, portable terminal identification information attached to the contents is compared with the portable terminal identification information of the portable terminal. According to the comparison result, it is determined whether the contents are to be reproduced. This will be described in more detail with reference to FIG. 2B.

Referring to FIG. 2B, the controller 10 determines whether the user has requested reproduction of contents among the stored contents through the keypad 27 in step 217. If he has, the controller 10 reads the contents and portable terminal identification information attached to the contents in a header field from the memory 29 in step 219. The portable terminal identification information is an MIN and an ESN, as described before.

The controller 10 compares the read portable terminal identification information with the portable terminal identification information of the portable terminal in step 221. If the contents were downloaded directly from the contents server, the portable terminal identification information is identical to the portable terminal identification information of the portable terminal. On the other hand, if the contents were received from another portable terminal such as a friend's or family member's, they are different.

Therefore, if the portable terminal identification information attached to the contents is identical to the portable terminal identification information of the portable terminal, the controller 10 reproduces the contents normally and displays them on the display 80 in step 234. If they are different, the controller 10 performs a non-reproduction operation on the contents in step 225.

Specifically, the controller 10 can display a message notifying that the contents have not been registered normally on the display 80. Or it can display a message asking whether to register the contents normally and a menu by which the user can select an answer about the contents registration. The user views the message and determines whether to register the contents through the keypad 27. If the user determines to register the contents in step 227, the controller 10 is connected to the contents server and performs a normal contents registration procedure in step 229. On the contrary, if the user determines not to register the contents in step 227, the controller 10 deletes the contents from the memory 29 in step 235.

After the contents registration in step 229, the controller 10 determines whether the contents registration is accepted in step 231. If it is rejected, the controller 10 deletes the contents from the memory 29 in step 235. If the registration is accepted, the controller 10 stores the portable terminal identification information of the portable terminal in the header field of the contents in step 233 and reproduces the contents in step 234.

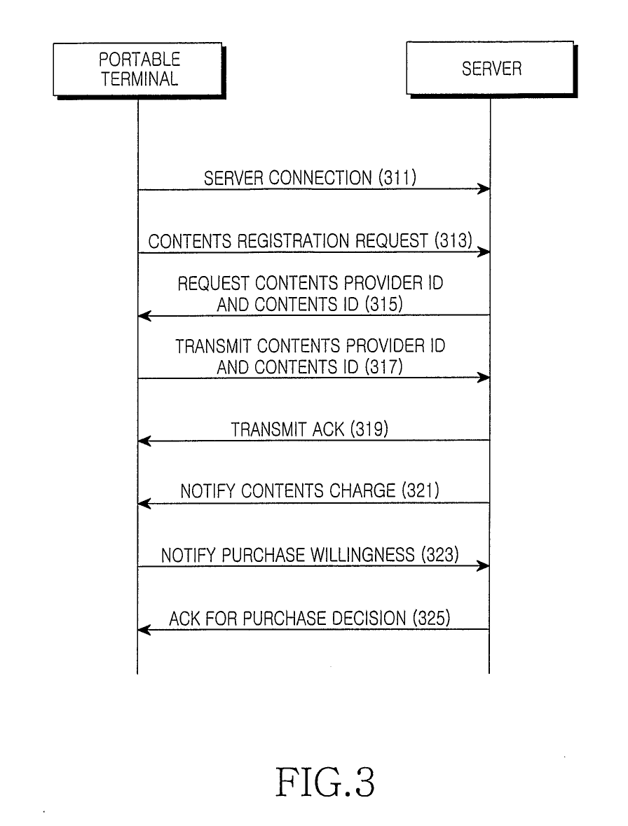

The contents registration procedure of step 229 will be detailed with reference to FIG. 3. FIG. 3 is a detailed flowchart illustrating the normal contents registration procedure in FIG. 2B.

Referring to FIG. 3, the portable terminal is connected to the contents server in step 311 and requests registration of the contents to the contents server in step 313.

In step 315, the contents server asks the portable terminal the ID of a contents provider that provides the contents and the ID of the contents. The portable terminal transmits the IDs of the contents and contents provider to be registered to the contents server in step 317.

The contents server receives the IDs of the contents and contents provider successfully and transmits an ACK (Acknowledgement) signal indicating the successful reception of the IDs to the portable terminal in step 319.

In step 321, the contents server notifies the portable terminal of the charge of the contents. The user determines whether to purchase the contents referring to the information use charge displayed on the display 80.

If the user decides to purchase the contents, the portable terminal notifies the contents server of purchase willingness in step 323 and the contents server transmits an ACK signal for the purchase willingness notification to the portable terminal in step 325. The ACK signal is used to avoid any misunderstanding of unwillingness to buy the contents as purchase willingness due to data loss.

After the contents registration in the procedure of FIG. 3, the user, who was informed of the information use charge, finally determines whether to accept or reject the contents registration by the keypad 27. Returning to FIG. 2B, the controller 10 decides as to user acceptance or rejection of the contents registration in step 231. If the contents registration is accepted, the controller 10 updates the portable terminal identification information of the contents with the portable terminal identification information of the portable terminal in step 233.

That is, the portable terminal identification information attached to the contents received from another portable terminal is replaced by the portable terminal identification information of the portable terminal that reproduces the contents.

Therefore, the contents with the updated portable terminal identification information are reproduced normally in step 234.

As described above, the present invention allows contents exchange between terminals, charging them for the use of contents. Therefore, the contents can be reproduced with the information use charge only, not with charges for packet data.

While the invention has been shown and described with reference to a certain preferred embodiment thereof, it is a mere exemplary application. For example, while the present invention has been described in the context of a portable terminal, it is applicable to any type of terminal with the function of storing and reproducing contents including video, music, games, and data. Also, while MIN and ESN are used as portable terminal identification information in the description of the present invention, either of them can be used or any other identification number that identifies a terminal is available. Therefore, it will be understood by those skilled in the art that various changes in form and details may be made therein without departing from the spirit and scope of the invention as defined by the appended claims.

What is claimed is:

1. A method of storing and reproducing contents, comprising the steps of:
connecting to a contents sever, downloading contents from the contents server, and storing the downloaded contents along with terminal identification information of a first terminal by the first terminal;
transmitting the contents with the terminal identification information to a second terminal by the first terminal; and
comparing the terminal identification information attached to the contents with terminal identification information of the second terminal, and if the terminal identification information is identical, reproducing the contents by the second terminal.

2. The method of claim 1, further comprising the step of performing a non-reproduction operation on the contents by the second terminal, if the terminal identification information attached to the contents is different from the terminal identification information of the second terminal.

3. The method of claim 2, wherein the step of performing the non-reproduction operation comprises the step of deleting the contents.

4. The method of claim 2, wherein the step of performing the non-reproduction operation comprises the steps of:
connecting to the contents server and registering the contents to be reproduced;
updating the terminal identification information attached to the contents with the terminal identification information of the second terminal, if the contents registration is completed; and
deleting the contents if the contents registration is not completed.

5. The method of claim 4, wherein the contents registering step comprises the steps of
connecting to the contents server, requesting registration of the contents to the contents server, and transmitting identification information of the contents to the contents server;
displaying charge information of the contents if the contents charge information is received from the contents server; and
notifying the contents server of purchase willingness, if purchase of the contents is requested by a predetermined manipulation.

6. The method of claim 5, further comprising the step of receiving an acknowledgement signal for the contents identification information and receiving an acknowledgement signal for the purchase willingness from the contents server.

7. The method of claim 1, wherein the contents downloading step comprises the steps of:
connecting to the contents sever, receiving a table of contents from the contents server, and displaying the table of contents; and
notifying the contents server of contents selected by a predetermined manipulation among the table of contents and downloading the selected contents from the contents server.

8. The method of any of claim 1 to claim 7, wherein the terminal identification information is filled in a header field of a format of the contents and includes an ESN (Electronic Serial Number) of the terminal.

9. A method of storing contents in a terminal, comprising the steps of:
connecting to a contents server and downloading contents;
reading preliminarily stored terminal identification information; and
storing the downloaded contents together with the read terminal identification information.

10. The method of claim 9, wherein the terminal identification information is filled in a header field of a format for the contents.

11. The method of claim 9, wherein the contents downloading step comprises the steps of:
connecting to the contents sever, receiving a table of contents from the contents server, and displaying the table of contents; and
notifying the contents server of contents selected by a predetermined manipulation among the table of contents and downloading the selected contents from the contents server.

12. The method of claim 10 or claim 11, wherein the terminal identification information includes an ESN (Electronic Serial Number) of the terminal.

13. A method of reproducing contents in a terminal, comprising the steps of:
checking terminal identification information attached to stored contents;
comparing the terminal identification information attached to the contents with terminal identification information of the terminal; and
reproducing the contents, the terminal identification information attached to the contents with terminal identification information of the terminal.

14. The method of claim 13, further comprising the step of performing a non-reproduction operation on the contents, if the terminal identification information attached to the contents is different from the terminal identification information of the terminal.

15. The method of claim 14, wherein the step of performing the non-reproduction operation comprises the step of deleting the contents.

16. The method of claim 14, wherein the step of performing the non-reproduction operation comprises the steps of:
connecting to the contents server and registering the contents to be reproduced; and
updating the terminal identification information attached to the contents with the terminal identification information of the terminal, if the contents registration is completed.

17. The method of claim 16, further comprising the step of deleting the contents if the contents registration is not completed.

18. The method of claim 16 or claim 17, wherein the contents registering step comprises the steps of:
connecting to the contents server, requesting registration of the contents to the contents server, and transmitting identification information of the contents to the contents server;
displaying charge information of the contents if the contents charge information is received from the contents server; and
notifying the contents server of purchase willingness, if purchase of the contents is requested by a predetermined manipulation.

19. The method of claim 18, further comprising the step of receiving an acknowledgement signal for the contents identification information and receiving an acknowledgement signal for the purchase willingness from the contents server.
